(19) United States
(12) Patent Application Publication
(10) Pub. No.: US 2012/0056988 A1
(43) Pub. Date: Mar. 8, 2012

(54) 3-D CAMERA

(76) Inventors: David Stanhill, Hoshaya (IL); Omri Govrin, Karkur (IL); Yuval Yosef, Hadera (IL); Eli Turiel, Shimshit (IL)

(21) Appl. No.: 12/876,818

(22) Filed: Sep. 7, 2010

(51) Int. Cl. H04N 13/02; H04N 9/04

(52) U.S. Cl. 348/46; 348/280; 348/E13.047; 348/E09.002

(57) ABSTRACT

A 3-D camera is disclosed. The 3-D camera includes an optical system, a front-end block, and a processor. The front-end block further includes a combined image sensor to generate an image, which includes color information and near infra-red information of a captured object and a near infra-red projector to generate one or more patterns. The processor is to generate a color image and a near infra-red image from the image and then generate a depth map using the near infra-red image and the one or more patterns from a near infra-red projector. The processor is to further generate a full three dimensional color model based on the color image and the depth map, which may be aligned with each other.

### BACKGROUND

With a rapid increase in the speed at which information may be transferred over the network, it has become possible to deploy many applications. One such application includes interactive computing (such as tele-presence). For example, the tele-presence application is becoming increasingly popular and is to some extent at least changing the way in which human beings interact with each other using the network. Typically, an apparatus supporting applications such as interactive computation may include a communication device, a processing device, and image capturing device. The image capturing device may include a three-dimensional (3-D) image capturing systems such as a 3-D camera.

The current 3-D systems using invisible structured light require two separate cameras one for 3D recognition and other for color texture capturing. Such current 3-D systems may also require elaborate system for aligning the two images generated by separate 3-D recognition camera and color texture camera. Such an arrangement may be of considerable size and cost. However, it may be preferable to have a small and less costly image capturing device, especially, while the image capturing device is to be mounted on a mobile apparatus.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a combined image sensor 100 in accordance with one embodiment.

FIG. 2 illustrates a pixel distribution in each of the filter provisioned in the combined image sensor 100 in accordance with one embodiment.

FIG. 3 illustrates a front-end block 300 including the combined image sensor 100 used in a three-dimensional (3D) camera in accordance with one embodiment.

FIG. 4 illustrates a 3D camera, which uses the front-end block 300 in accordance with one embodiment.

FIG. 5 illustrates processing operations performed in a 3D camera after capturing the image in accordance with one embodiment.

FIG. 6 is a flowchart, which illustrates the operation of a 3-D camera in accordance with one embodiment.

### DETAILED DESCRIPTION

The following description describes a three-dimensional camera, which uses a color image sensor. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable storage medium may include any mechanism for storing or transmitting information in a form readable by a machine (e.g., a computing device).

For example, a machine-readable storage medium may include read only memory (ROM); random access memory (RAM); magnetic disk storage media; optical storage media; flash memory devices; electrical, optical forms of signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

In one embodiment, a 3-D camera may use a combined image sensor, which may sense both the color information and near infrared (NIR) radiation. In one embodiment, the combined image sensor may generate an image, which may include color information and NIR information, which may be used to reconstruct the depth information of a captured object. In one embodiment, the combined image sensor may include a color filter array (CFA), which may in turn include a 2×2 array to include four distinct filter types. However, other embodiments of the CFA may include 4×4 arrays (to include 16 filter types) and such other N×N or N×M size arrays. For example, in one embodiment, the four distinct filter types of the CFA may include a red filter type, a green filter type, and a blue filter type for capturing color radiations, and an additional band pass filter for capturing NIR radiation. In one embodiment, using the combined image sensor in a 3-D camera may result in a red, a green, a blue full image in addition to a NIR image at full or lower resolution. In an embodiment, by construction, the color image may be aligned with a 3-D depth map and as a result a 3-D image having complete color information and depth information may be reconstructed using compact and low-cost components. In one embodiment, such an approach may allow compact and low-cost 3-D cameras to be conveniently used, especially, in mobile devices such as laptops, net books, smart phones, PDAs, and other small form factor devices.

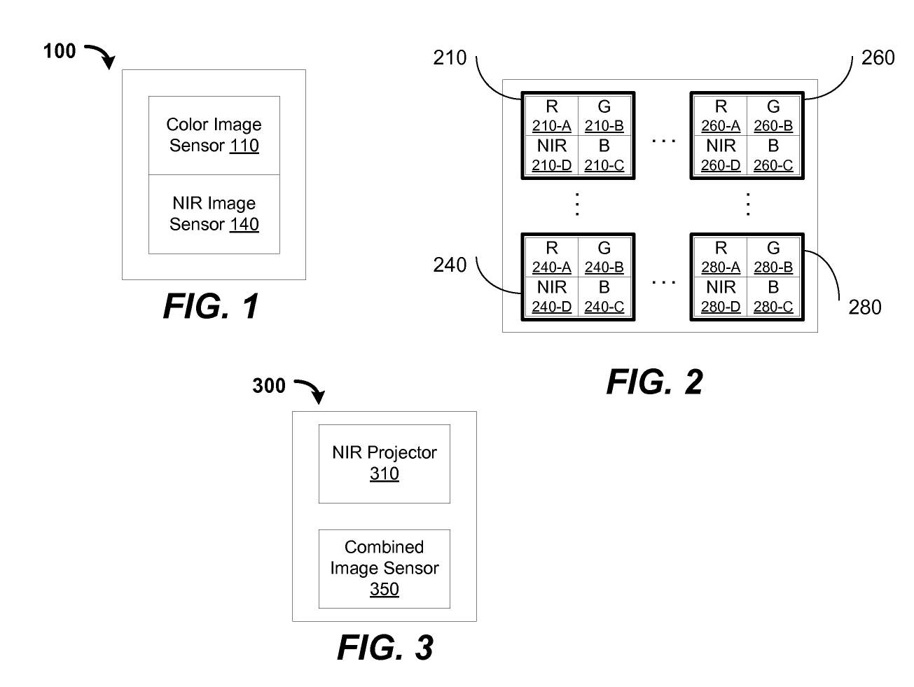

An embodiment of a combined image sensor 100 is illustrated in FIG. 1. In one embodiment, the combined image sensor 100 includes a color image sensor 110 and a NIR image sensor 140. In one embodiment, the combined image sensor 110 may generate an image, which may include color information and NIR information from which the depth information of a captured object may be extracted. In one embodiment, the combined image sensor 100 may include CFA, which may include distinct filter types to capture color information and a band pass filter to capture near infrared (NIR) radiation.

In one embodiment, each periodic instance of the CFA such as 210, 240, 260, and 280, shown in FIG. 2, may comprise four distinct filter types that may include a first filter type that may represent a first basic color (e.g., Green (G)), a second filter type that may represent a second basic color (e.g., Red (R)), a third filter type that may represent a third basic color (e.g., Blue (B)) to capture color information, and a fourth filter type that may represent a band pass filter to allow NIR radiation. In one embodiment, the first periodic instance of the CFA 210 may include four distinct filter types 210-A, 210-B, 210-C, and 210-D. In one embodiment, the first filter type 210-A may act as a filter for red (R) color, the second filter type 210-B may act as a filter for green (G) color, the third filter type 210—may act as a filter for blue (B) color, and the fourth filter type 210-D may act as a band pass filter to allow NIR radiation.

Likewise, in one embodiment, the second, third, and the fourth periodic instances 240, 260, and 280 may include filter types (240-A, 240-B, 240-C, and 240-D), (260-A, 260-B, 260-C, and 260-D) and (280-A, 280-B, 280-C, and 280-D), respectively. In one embodiment, the filter types 240-A, 260-A and 280-A may represent a red color filter, the filter types 240-B, 260-B and 280-B may represent the green color filter, the filter types 240-C, 260-C, and 280-C may represent the blue color filter, and the filter types 240-D, 240-D, and 280-D may represent the band pass filters to allow NIR radiation.

In one embodiment, arranging RGB and NIR filter types in an array may allow the combined color and NIR pattern to be captured. In one embodiment, the combined color and NIR pattern may result in a full image of red, green, and blue, in addition to a NIR image of full or lower resolution. In one embodiment, such an approach may allow the RGB image and the depth map, which may be extracted from the NIR pattern to be aligned to each other by the construction of the combined imager sensor.

An embodiment of a front-end block 300 including the combined image sensor 100 used in a three-dimensional (3D) camera is illustrated in FIG. 3. In one embodiment, the front-end block 300 may include a NIR projector 310 and the combined image sensor 350. In one embodiment, the NIR projector 310 may project structured light on an object. In one embodiment, the structured light may refer to the light pattern including lines, other patterns, and/or the combination thereof.

In one embodiment, the combined image sensor 350 may sense both the color information and near infrared (NIR) radiation in response to capturing color texture and depth information of an object, image, or a target. In one embodiment, the combined image sensor 350 may include one or more color filter arrays (CFA). In one embodiment, the filter types within each periodic instance may sense color information and NIR radiation as well. In one embodiment, the combined image sensor 350 may result in a red, a green, a blue full image in addition to a NIR image at full or lower resolution. In an embodiment, by construction of the color image sensor 350, the color image generated form the color information may be aligned with a 3-D depth map that may be generated from the NIR radiation. As a result a 3-D image having complete color information and depth information may be reconstructed using compact and low-cost components. In one embodiment, the combined image sensor 350 may be similar to the combined image sensor 110 described above.

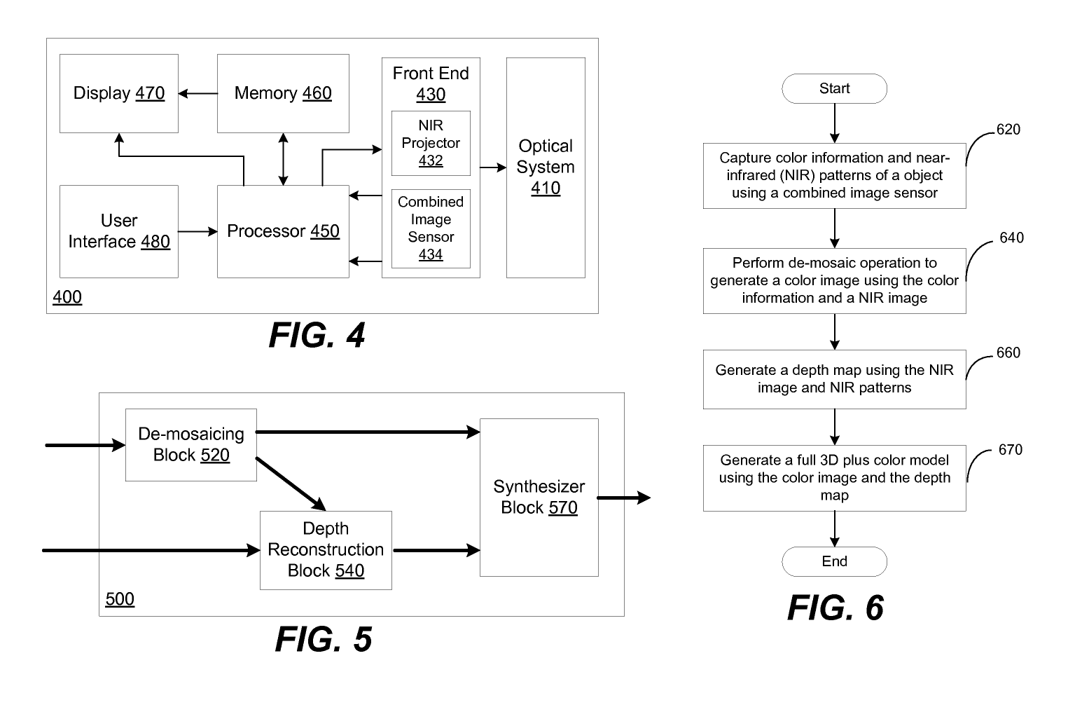

An embodiment of a 3-D camera 400 is illustrated in FIG. 4. In one embodiment, the 3-D camera 400 may include an optical system 410, a front-end block 430, a processor 450, a memory 460, a display 470, and a user interface 480. In one embodiment, the optical system 410 may include optical lenses to direct the light source, which may include both the ambient light and the projected NIR radiation, to the sensors and to focus the light from the NIR projector on the scene.

In one embodiment, the front-end block 430 may include a NIR projector 432 and a combined image sensor 434. In one embodiment, the NIR projector 432 may generate structured light to be projected on a scene, image, object, or such other targets. In one embodiment, the NIR projector 432 may generate one or more patterns of structured light. In one embodiment, the NIR projector 432 may be similar to the NIR projector 310 described above. In one embodiment, the combined image sensor 434 may include CFA to capture color texture of the target and the NIR information capturing the structured light emitted from the NIR projector 432. In one embodiment, the combined image sensor 434 may generate an image, which may include color information and NIR information (from which the depth information/map may be extracted) of a captured object. In one embodiment, the image including color information and NIR information and the one or more patterns formed by the structured light may together enable reconstruction of the target in 3-D space. In one embodiment, the combined image sensor 434 may be similar to the combined image sensor 350 described above. In one embodiment, the front-end block 430 may provide color image and the NIR patterns to the processor 450.

In one embodiment, the processor 450 may reconstruct the target image in a 3-D space using the color image and the NIR patterns. In one embodiment, the processor 450 may perform de-mosaicing operation to interpolate color information and NIR information in the image to, respectively, produce a ‘full-colored image’ and a ‘NIR image’. In one embodiment, the processor 450 may generate a ‘depth map’ by performing depth reconstruction operation using the ‘one or more patterns’ generated by the NIR projector 432 and the ‘NIR image’ generated by the de-mosaicing operation. In one embodiment, the processor 450 may generate a ‘full 3-D plus color model’ by performing a synthesizing operation using the ‘full-colored image’ and the ‘depth map’. In one embodiment, the processor 450 may reconstruct a ‘full 3-D plus color model’ substantially easily as the color image and the depth map may be aligned with each other due to the construction of the combined image sensor 434.

In one embodiment, the processor 450 may store the ‘full 3-D plus color model’ in the memory 460 and the processor 450 may allow the ‘full 3-D plus color model’ to be rendered on the display 470. In one embodiment, the processor 450 may receive inputs from the user through the user interface 480—and may perform operations such as zooming-in, zooming-out, storing, deleting, enabling flash, recording, enabling night vision operations.

In one embodiment, the 3-D camera using the front-end device 430 may be used in mobile devices such as lap-top computer, note-book computers, digital cameras, cell phones, hand-held devices, personal digital assistants, for example. As the front-end block 430 includes a combined image sensor 434 to capture both color and NIR information the size and cost of the 3D camera may be decreased substantially. Also, the cost and complexity of processing operations such as depth reconstruction, and synthesizing may be performed with substantial ease and reduced cost as the color information and depth information may be aligned to each other. In one embodiment, the processing operations may be performed in hardware, software, or a combination of hardware and software thereof.

An embodiment of the operations performed by the processor 450 of the 3-D camera 400 is illustrated in FIG. 5. In one embodiment, the processor 450 may perform reconstruction operation to generate a full 3-D plus color model. In one embodiment, the reconstruction operation may include de-mosaicing operation supported by a de-mosaicing block 520, a depth reconstruction operation represented by the depth reconstruction block 540, and a synthesizing operation performed by a synthesizer block 570.

In one embodiment, the de-mosaicing block 520 may generate a color image and a NIR image in response to receiving color information from the combined image sensor 434 of the front-end block 430. In one embodiment, the color image may be provided as an input to the synthesizer block 570 and the NIR image may be provided as an input to the depth reconstruction block 540.

In one embodiment, the depth reconstruction block 540 may generate a depth map in response to receiving the NIR patterns and the NIR image. In one embodiment, the depth map information may be provided as an input to the synthesizer block 570. In one embodiment, the synthesizer block 570 may generate a full 3-D color model in response to receiving the color image and the depth map, respectively, as a first input and a second input.

An embodiment of an operation of the 3D camera is illustrated in flow-chart of FIG. 6. In block 620, the combined image sensor 434 may capture color information and NIR patterns of a target or an object.

In block 640, the processor 450 may perform a de-mosaicing operation to generate a color image and a NIR image in response to receiving the information captured by the combined image sensor 434.

In block 660, the processor 450 may perform a depth reconstruction operation to generate a depth map in response to receiving the NIR image and the NIR patterns.

In block 680, the processor 450 may perform synthesizing operation to generate a full 3-D color model using the color image and the depth map.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method in a three dimensional camera, comprising:
generating an image using a combined image sensor, wherein the image is to include color information and near infra-red information of a captured object,
generating a color image and a near infra-red image from the image,
generating a depth map using the near infra-red image and one or more patterns from a near infra-red projector, and
generating a full three dimensional color model based on the color image and the depth map.

2. The method of claim 1 comprises capturing the color information using a first portion of a color filter array, wherein the combined image sensor includes the color filter array.

3. The method of claim 2 comprises capturing the color image using the first portion of the color filter array, which include a first filter type to capture red color, a second filter type to capture green color, and a third filter type to capture blue color of the object.

4. The method of claim 2 comprises capturing the near infra-red information using the second portion of the color filter array.

5. The method of claim 4 comprises including a band pass filter in the second portion of the color filter array to capture the near infra-red information.

6. The method of claim 2, wherein the color information is aligned with the depth map.

7. The method of claim 1 comprises performing a de-mosaicing operation to generate the color image and the near infra-red image from the image.

8. The method of claim 1 comprises performing a depth reconstruction operation to generate the depth map from the one or more patterns.

9. The method of claim 1 comprises performing a synthesizing operation to generate the full three dimensional color model based on the color image and the depth map.

10. An apparatus, comprising:
a near-infra red projector to generate one or more patterns, and
a combined image sensor, wherein the combined image sensor is to include color filter array, wherein color filter array is to generate an image, which includes color information and near infra-red information of a captured object,
wherein the color information is used to generate a color image and the near infra-red information is used to generate a near infra-red image,
wherein the near infra-red image and the one or more patterns are used to generate a depth map, and
wherein the color image and the depth map are used to generate a full three dimensional color model.

11. The apparatus of claim 10, wherein the color filter array comprises a first portion to capture the color information.

12. The apparatus of claim 11, wherein the first portion of the color filter array includes a first filter type to capture red color, a second filter type to capture green color, and a third filter type to capture blue color of the object before generating the color image.

13. The apparatus of claim 11, wherein the color filter array further includes a second portion, wherein the second portion is to capture the near infra-red information.

14. The apparatus of claim 13, wherein the second portion of the color filter array includes a band pass filter to capture the near infra-red information.

15. The apparatus of claim 10, wherein the color filter array is to generate the color information, which is aligned with the near infra-red information.

16. A three dimensional camera system, comprising:
an optical system, wherein the optical system is to direct a light source, which may include ambient light and projected near infra-red radiation and to focus the near infra-red radiation projected on an object,
a front-end block coupled to the optical system,
a processor coupled to the front-end block, and
a memory coupled to the processor,
wherein the front-end block further includes a combined image sensor and a near infra-red projector, wherein the combined image sensor is to generate an image, which includes color information and near infra-red information of a captured object and the near infra-red projector is to generate one or more patterns,
wherein the processor is to generate a color image and a near infra-red image from the image, generate a depth map using the near infra-red image and one or more patterns from a near infra-red projector, and generate a full three dimensional color model based on the color image and the depth map.

17. The three dimensional camera system of claim 16, wherein the combined image sensor further comprises a color filter array, wherein color filter array is to comprise a first portion and a second portion, wherein the first portion of the color filter array is to capture the color information.

18. The three dimensional camera system of claim 17, wherein the first portion of the color filter array is to include a first filter type to capture red color, a second filter type to capture green color, and a third filter type to capture blue color of the object to generate the color information.

19. The three dimensional camera system of claim 17, wherein the second portion of the color filter array is to capture the near infra-red information.

20. The three dimensional camera system of claim 19, wherein the second portion of the color filter array includes a band pass filter to capture the near infra-red information.

21. The three dimensional camera system of claim 17, wherein the arrangement of the first portion and the second portion within the color filter array is to align the color information with the depth map.

22. The three dimensional camera system of claim 16, wherein the processor is to perform a de-mosaicing operation to generate the color image and the near infra-red image from the image.

23. The three dimensional camera system of claim 16, wherein the processor is to perform a depth reconstruction operation to generate the depth map from the near infra-red image and the one or more patterns.

24. The three dimensional camera system of claim 16, wherein the processor is to perform a synthesizing operation to generate the full three dimensional color model based on the color image and the depth map.
